(19) United States
(12) Patent Application Publication
(10) Pub. No.: US 2022/0101262 A1
(43) Pub. Date: Mar. 31, 2022

(54) DETERMINING OBSERVATIONS ABOUT TOPICS IN MEETINGS

(71) Applicant: Hewlett-Packard Development Company, L.P., Spring, TX (US)

(72) Inventors: Christoph Graham, Spring, TX (US); Chi So, Spring, TX (US)

(73) Assignee: Hewlett-Packard Development Company, L.P., Spring, TX (US)

(21) Appl. No.: 17/427,240

(22) PCT Filed: May 28, 2019
(86) PCT No.: PCT/US2019/034095

§ 371 Date: Jul. 30, 2021

(51) Int. Cl. G06Q 10/10

(52) U.S. Cl. CPC G06Q 10/10; G06N 20/00

(57) ABSTRACT

In some examples a computing device can determine observations about topics in meetings by receiving information from a plurality of devices during a meeting, analyzing the received information via machine learning, determining an observation about a topic presented during the meeting using the analyzed information, and generating an output including the observation.

### BACKGROUND

Meetings can include assembly of people, such as the members of a society or committee, among other examples, for a discussion. Some meetings may include participants who are all gathered in a common location. Some meetings may include participants who may not necessarily gather in a same space. For example, some participants to a meeting may be located in an area that is different from other participants to the meeting.

Regardless of where meeting participants may be located, communication tools may be utilized during a meeting. For example, communication tools can be used in meetings such that participants may see each other, hear each other, and share media with each other. In some examples, user may see each other, hear each other, and share media with each other by using different applications.

### BRIEF DESCRIPTION OF THE DRAWINGS

FIG. 1 illustrates an example of a system suitable to determine observations about topics in meetings consistent with the disclosure.

FIG. 2 illustrates a block diagram of an example computing device to determine observations about topics in meetings consistent with the disclosure.

FIG. 3 illustrates a block diagram of an example system consistent with the disclosure.

FIG. 4 illustrates an example of a method for determining observations about topics in meetings consistent with the disclosure.

### DETAILED DESCRIPTION

The general task of meetings can include a high percentage of workforce activity within an organization. The bulk of meeting management, archiving historical record, and tracking may fall upon human operators acting in the role of topic leads or group coordinators. As used herein, the term “topic” refers to a sentence and/or a part of a sentence that announces the item about which the rest of the sentence communicates information. In some examples, the topic can be signaled by initial position in the sentence. In some examples, the topic can be signaled by a grammatical marker.

In some examples, communication managements tools may manage meeting minutes, collect data from meetings, and archive the collected data. Communication management tools may archive a call in a video or an audio format. In some examples, a meeting participant may be recognized using the video and/or audio archive. In some examples, the audio, video, and meeting material can be stored in a shared workspace. In some examples, the meeting materials can be searchable based on subject/and or material. However, such communication tools can be limited to a word search, and/or bookmarks to search the subject and/or material of the meeting.

A computing device that analyzes an observation about a topic presented in the meeting, categorizes the observation, and generates context-specific output based on the observation over a series of collaboration events can provide a holistic view of a meeting and/or a topic. As used herein, the term “observation” refers to sensory inputs received via a sensor and information about physical content (e.g., presentation content presented using digital media, white board content presented during the meeting, etc.) received from the meeting. As used herein, the term “sensor” refers to a subsystem that detects events or changes in its environment and sends the collected data to other systems, frequently a computer processor. As used herein, the term “sensory input” refers to physical properties such as mood, enthusiasm, verbal engagement, eye movement, physical movement etc. captured by the sensor.

A computing device that analyzes an observation about a topic presented in the meeting, categorizes the observation, and generates context-specific output based on the observation about the topic, can streamline workflow and help track progress, observe human interaction over the course of multiple collaboration sessions and/or across an entire organization, help prioritize projects and identify stakeholders. As used herein, the term “context-specific output” refers to a form of optimizing search results based on context provided by a user.

Accordingly, the disclosure is directed towards determining observations about topics in meetings. For example, a computing device can receive information from multiple devices during a meeting and analyze the information via machine learning to determine an observation (e.g., sensory inputs such as mood, enthusiasm, and artifacts such as content) about a topic presented during the meeting. As used herein, the term “device” refers to an object, machine, or piece of equipment that has been made for some special purpose. In some examples, the device can include sensors, cameras, microphones, computing devices phone applications, voice over Internet Protocol (VoIP) applications, voice recognition applications, digital media, etc. As used herein, the term “machine learning” refers to an application of artificial intelligence (AI) that provides systems the ability to automatically learn and improve from experience without being explicitly programmed.

The computing device can receive information from multiple devices during a meeting and analyze the information via machine learning to determine an observation. Additionally, the computing device can collate the analyzed information to categorize the observation. The computing device can generate context-specific outputs based on the observation. The outputs can be over a series of collaboration events. Outputs can be created using natural language questions and queries presented to the computing device.

Outputs can be based on direct and/or inferred observations. As used herein, the term “direct” refers to an observation created in response to an explicit input and/or instruction. As used herein, the term “inferred” refers to an observation derived by reasoning from premised and/or evidence based on patterns and inference. In some examples, machine learning algorithms can analyze information based on direct and/or inferred observations.

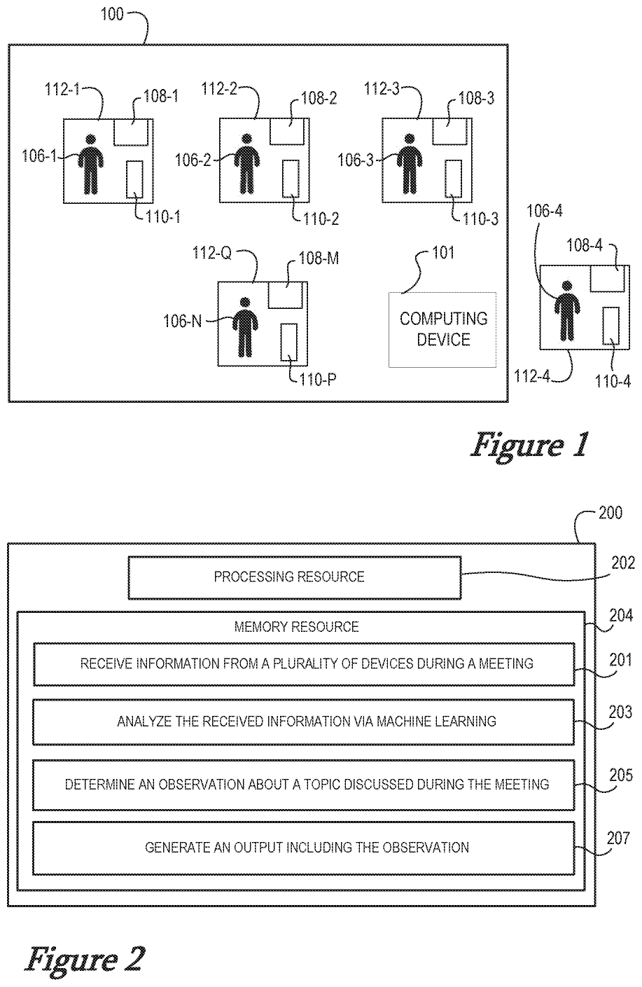

FIG. 1 illustrates an example of a system 100 suitable to determine observations about topics in meetings consistent with the disclosure. As illustrated in FIG. 1, the system 100 can include computing device 101, meeting locations 112-1, 112-2, 112-3, 112-4, and 112-Q. Meeting locations 112-1, 112-2, 112-3, 112-4, and 122-Q can be referred to collectively herein as meeting locations 112. In some examples, meeting locations 112 can include participants 106-1, 106-2, 106-3, 106-4, 106-N, content 110-1, 110-2, 110-3, 110-4, 110-P, and devices 108-1, 108-2, 108-3, 108-4, and 108-M. Participants 106-1, 106-2, 106-3, 106-4, 106-N can be referred to collectively herein as participants 106. Devices 108-1, 108-2, 108-3, 108-4 and 108-M can be referred to collectively herein as devices 108. Content 110-1, 110-2, 110-3, 110-4, 110-P can be referred to collectively herein as contents 110.

In some examples, participants 106 can be located in a single meeting location (e.g., 112-1). In some examples, participants 106 can be located in plurality of meeting locations. For example, participant 106-1 can be in a first meeting location 112-1, participant 106-2 can be in a second meeting location 112-2, etc.

In some examples, participants 106 can participate in the meeting from a remote location. As described herein, the term “remote location” refers to a location that is located away from a central meeting location (e.g., 112-1). For example, the meeting can be held in the first meeting location and the participant can be located in a remote location (e.g., second location, third location, etc.). The system 100 can receive information (e.g., participants, content, etc.) from devices 108-1 from the first location and information (e.g., participant 106-2, content 110-2 etc.) from a second/remote location from device 108-2.

Devices 108 can include sensors, cameras, microphones, computing devices, phone/mobile device(s) and/or mobile device applications, voice over Internet Protocol (VoIP) applications, voice recognition applications, digital media etc. In some examples, information about the participants 106 can be received using the devices 108. For example, device 108-1 of devices 108 can be a camera to take images and/or video of participants 106. Similarly, an audio recording device 108-2 can take audio recording of the participants 106.

The system 100 can receive information from meeting locations 112 using plurality of the devices 108. In some examples, information can be received from each of the meeting locations 112. Information received from the plurality of devices 108 can include audio of the meeting, video of the meeting, presentation content and/or white board content presented during the meeting, as is further described herein.

In some examples, audio information received from the meeting can include audio recording taken by an audio recording device (microphone, speaker, etc.). In some examples, the audio recording device can audibly recognize participants 108 based on sound signals received from the participants compared with sound signals in a database.

In some examples, video information received from the meeting can include digital images taken by a visual image capturing device. For example, a visual image capturing device 108-1 (e.g., camera) can take images and/or video of participants 106.

In some examples, information received from the meeting can include presentation content and white board content presented during the meeting. For example, information received from devices 108 can include presentation content 110 from the meeting locations 112. In some examples, the visual image capturing device 108-1 can take images of the presentation content 110-2 and audio recording device 108-2 can record audio of the meeting from meeting location 112-2. The system 100 can receive information about the presentation content 110-2 and audio recording of the meeting from audio recording device 108-2. In some examples, video capture software may be utilized to record presentation content presented during the meeting.

In some examples, devices 108 can be located in one meeting location (e.g., 112-2) and track participants 106 from the plurality of meeting locations (112-1, 112-3, 112-4, etc.). For example, an audio recording device 108-2 can be in the meeting location 112-2 and can record information received from meeting locations 112-3, 112-4, etc.) about participants 106 and contents 110.

System 100 can receive information from devices such as cameras, sensors, microphones, phone applications, voice over Internet Protocol (VoIP) applications, voice recognition applications, and/or digital media, etc., as is further described herein.

In some examples, devices 108 can include a camera that can take an image of the participant. In some examples, the image taken by the camera (e.g., 108-1) can identify participant 106-1 via facial recognition application. As used herein, the term “facial recognition” can, for example, refer to identifying a unique person from a digital image or video frame from a video source. For example, device 108-1 may be a camera that captures a digital image and/or video including video frames, where a particular participant 106-1 may be included in the digital image and/or video frame, and system 100 can identify the user via facial recognition, as is further described herein. In some examples, the image taken by the camera can include images of content presented during the meeting.

In some examples, devices 108 can include a sensor that can detect sensory inputs received from the participants 106. Sensory inputs can include enthusiasm, verbal engagement, and physical gestures captured by the devices 108, as is further described herein, The system 100 can receive information from the sensor (e.g., such as device 108-3) that can detect sensory inputs from the participants 106.

In some examples, devices 108 can include a microphone that can capture audio of the participants 106 by converting sound waves into electrical signals. The system 100 can receive information from the microphone (e.g., such as device 108-2) to determine the identity of the participants, as is further described herein.

System 100 can analyze the received information via machine learning. For example, the system 100 can receive information from devices 108 during the meetings and analyze the information via machine learning. For example, system 100 can receive information about participants 106 and contents 110 related to a topic from devices 108. Based on the received information, system 100 can analyze the information via machine learning. For example, system 100 can receive audio of the meeting, video of the meeting, and presentation content presented at the meeting from devices 108. System 100 can, via machine learning, analyze each information (e.g., such as the audio of a meeting, video of a meeting, presentation content of a meeting, etc.) received from each of the types of devices 108. In some examples, the system 100 can categorize the analyzed information, as described herein.

In some examples, analyzing the received information can include identifying a meeting participant associated with the received information from the plurality of devices 108. For example, device 108-1 of the devices 108 can be a camera that can take an image and/or a video of a participant 106-1 in a meeting and determine an identity of the participant via facial recognition. The identity of the participant 106-1 can be determined by, for instance, comparing facial features of the participant 106-1 from an image including facial features of the participant 106-1 taken by camera 108-1 with facial images in a database (not shown in FIG. 1) of facial images. Based on the comparison of the image from camera 108-1 and the database of facial images, an identity of the participant 106-1 can be determined. That is, if the facial images of the image from camera 108-1 match the facial images included in images of the database of facial images, an identity of the participant 106-1 can be determined.

In some examples, the meeting participant can be identified by his/her employee identity badge (e.g., using Near Field Communication (NFC) technology standard based on Radio Frequency Identification (RFID)). For example, an identity of the participant 106-2 can be determined by comparing an employee identity badge with information within an employee information database. In some examples, the employee identity badge can be scanned using NFC and/or RFID scanning.

In some examples, a meeting participant can be identified via phone and/or scanning Bluetooth devices. For example, identity of the participant 106-3 can be determined by scanning the phone and/or Bluetooth device that has been assigned to participant 106-3. The unique identifier of the phone and/or Bluetooth device (e.g., such as a media access control (MAC) address) can be compared with information or unique identifiers within a database of devices assigned to and/or associated with the participants.

In some examples, a meeting participant can be identified via the invitee list. For example, a meeting organizer can generate an invitee list and participants from the list can be identified based on names, location, department, etc. In some examples, a participant not on the invitee list can be identified. For example, a participant not on the invitee list can be identified via facial recognition, as previously described herein. In some examples, the feedback received from a participant not on the invitee list can be categorized and be included in a future invitee list.

System 100 can determine an observation about a topic presented during the meeting using the analyzed information. In some examples, the observation can be categorized based on context. In some examples, context can be participation status (active versus passive participants). For example, system 100 can make an observation that participant 106-1 and participant 106-2 are more enthusiastic about a topic when they are identified as active participants in a first meeting and less enthusiastic about the same topic when they are identified as passive participants in a second meeting. In some examples, context can be the topic of the conversation. For instance, system 100 can make an observation that a first topic (e.g., discussion about employee benefits) has more participants participating in the meetings than a second topic (e.g., increase in stock price). In some examples, context can be the amount of time spent on a topic. In some examples, context can be the amount of time spent on topics that are related to a specific topic For example, system 100 can make an observation that spending more time about a topic (e.g., detailed discussion about company's goals and product pipeline) in a first meeting can result in a positive outcome for related topics (approval for job requisition) in a second meeting. In some examples, system 100 can create links based on the contexts within a database.

In some examples, system 100 can receive information about participants 106 from devices 108 and determine the context of the observation. For example, system 100 can analyze the information via machine learning and categorize the observation. For example, system 100 can make an observation regarding the participants who may have consented to a topic by comparing previously recorded meetings and/or sensory inputs. In some examples, consent from the participant 106-1 can be determined by, for instance, comparing keywords used by the participant 106-1 captured by the microphone 108-4 with a database (not shown in FIG. 1) of keywords that marks the words as “consent”.

In some examples, an observation can include determining a sensory input regarding meeting participants 106 during the meeting. In some examples, sensory inputs can include enthusiasm, verbal engagement, physical gestures captured by the devices 108, among other examples. For example, system 100 can determine an observation that participants 106 agreed on a first topic (e.g., increase budget for research and development) based on the participant's enthusiasm captured by devices 108. The enthusiasm of the participants 106 can be determined by, for instance, comparing energy and interest of the participants 106 with a database of responses received from participants 106 at a different time period about the same and/or a different topic. In some examples, system 100 can determine an observation that participants 106 agreed on the first topic based on the participant's verbal agreement. For example, if the participants use a keyword (e.g., agree, accept etc.) regarding the topic, the system 100 can make the observation that the participants are in agreement. In some examples, system 100 can determine an observation that participants 106 agreed on the first topic based on the participant's physical gesture (e.g., a nod of the head) regarding the first topic.

In some examples, system 100 can determine an observation that can include identifying meeting participants 106 who responded to the topic. Responses for the topic can include verbal engagement about the topic. For example, system 100 can make an observation that participant 106-1 and participant 106-2 responded to a topic regarding budget increase based on their verbal engagement during the meeting. Responses for the topic can include sensory input about the topic. For example, system 100 can make an observation that participant 106-3 responded to the budget increase topic based on a physical gesture received from the participant, for instance participant taking notes during the meeting, captured by devices 108.

In some examples, system 100 can make an observation that includes summarizing content 110 related to a topic presented during the meeting. For example, meeting location 112-1 can include content 110-1 related to a first topic presented using digital media, meeting location 112-2 can include content 110-2 related to the first topic presented using white board content. In some examples, system 100 can summarize the content by combining the contents 110-1 and 110-2 related to the first topic and provide a brief statement about the content. For example, content 110-1 can include plurality of digital slides, portions of which may include a budget for 2019. Similarly, content 110-2 can include a plurality of topics, a portion of which includes budget information for 2019. System 100 can combine the content from 110-1 and 110-2 related to the budget topic and summarize the content.

In some examples, system 100 can make an observation that includes tracking progress about the topic presented during the meeting. For example, system 100 can make an observation about the first meeting during a first time period, and a second meeting during a second time period. Based on the information received from the two meetings, system 100 can track progress. For example, system 100 can make an observation that the topic presented during the first and the second meeting has reached a milestone (e.g., a draft budget for the year 2019 is reached).

In some examples, system 100 can make an observation that includes direct observations and inferred observations over time related to the meeting relating to the topic for a data model. As described herein, the term “data model” refers to an abstract model that organizes elements of data and standardizes how they relate to one another. For example, system 100 can determine an observation about a topic presented during a meeting using the analyzed information. The data model can organize the observation (e.g., words spoken, physical gestures, identity of the participants, etc.) and standardize how various observations relate to each other. For example, system 100 can determine an observation that an identified participant 106-1 is located in a meeting location 112-1 and responds positively about a first topic during a first time period, a second time period and a third time period. The data model can standardize the responses from participant 106-1 received from a plurality of time periods. Based on that information, system 100 can determine that the participant 106-1, located in meeting location 112-1 is in favor of the first topic.

In some examples, system 100 can make an observation in response to an explicit instruction. For instance, an instruction to find out an identity of the participants 106. In some examples, system 100 can make an observation based on evidence and/or reason. For example, system 100 can determine the first participant 106-1 consents to a specific topic during a first meeting, second meeting, and third meeting. Based on that evidence, system 100 can infer that participant 106-1 may consent to the same topic during a fourth meeting.

In some examples, system 100 can make a forecast based on the inferred observation. For example, system 100 can identify participants who responded in relation to a topic (e.g., budget increase) and provide their sentiment to the topic based on observations of their responses. The positive and/or negative sentiment toward the given topic for the related participant can be postulated based on the known shared sentiments with other participants in a form of common ground collection of ideas. For example, if a group of participants share a similar sentiment on a topic, they will likely form a similar opinion to a related topic. In some examples, the related topics can be less related to each other, in which case the outcome may be less predictable.

System 100 can collate the analyzed information to categorize an observation. For example, system 100 can collect data about a specific topic, determine an observation about the specific topic, and organize the topic based on a context, as is further described herein. For example, system 100 can look for overlap within an enterprise to identify efficiencies, and/or areas where multiple collaborating groups can intersect and share information. In some examples, system 100 can collate the categorized observation by identifying topics and topic complexity by building a graph network of interlinked topics. Based on the graph, system 100 can, for instance, identify topics that occur more or less frequently within the enterprise.

In some examples, system 100 can collate analyzed information to categorize an observation by looking for disparities and/or outside-of-normal behaviors. For example, a participant can have different responses for the same topic at different time periods. Participant 106-1 can, for instance, argue for budget increase in a first meeting and can argue against budget increase in a second meeting. The system 100 can collect information about the participant's response in both meetings and make an observation that the context of the first meeting was different from the context of the second meeting.

In some examples, system 100 can collate the analyzed information to categorize an observation which can be used to make a decision. For example, system 100 can make observations of consistent negative sentiment. System 100 can, for instance, determine that consistent negative sentiment can cause destruction to productivity of the participants and/or the interacting team and use that information to leave certain participants out of future meetings.

System 100 can generate an output including the observation, In some examples, the output can be a hard copy, a soft copy, a digitized speech, etc. In some examples, the system 100 can generate a direct output. For example, the output can be a direct output directly related to an input from the participant and/or system. For example, a participant 106 can submit a query to determine how many participants are in a first location. The output in such an instance can be the number of participants in the first location, and may be presented by displaying the number of participants in the first location on a screen, describing the number of participants via an audio output through a speaker, and/or displaying the number of participants on a hard copy such as a printed piece of paper, among other examples. In some examples, the system 100 can generate an inferred output. For example, the system 100 can make an observation about the number of personal computers used in the meeting and generate an output about the number of participants in the first location. In some examples an output can be based on a natural input. A natural input can include a natural language spoken by participants 106, sign language used by participants 106, and other physical gestures used by participants, as described herein.

In some examples, the system 100 can generate an output based on a direct observation. For example, system 100 can include an observation created in response to an instruction, for instance, instruction to find out the identity of the participants. In some examples, the system 100 can generate an output based on an inferred observation. The output in such an instance can be the number of participants in the first location. For example, system 100 can determine that the first participant consents to a specific topic during a first meeting, second meeting and third meeting. Based on that observation, system 100 can infer that the first participant may consent to the same topic during a fourth meeting. The output may be presented by displaying the output on a screen, describing the output audibly via an audio output through a speaker, and/or displaying the output on a hard copy such as a printed piece of paper, among other examples.

In some examples, the system 100 can generate an output that includes the categorized observation about the topic. For example, categorized observation can include any subtopic of the topic. If the topic, for example, is “2019 budget”, the subtopic can include employee statistics, capital cost, R&D cost, salary, etc. The system 100 can generate an output that categorizes the observation based on each of the subtopics described herein. The output may be presented by displaying the output on a screen, describing the output audibly via an audio output through a speaker, and/or displaying the output on a hard copy such as a printed piece of paper, among other examples.

In some examples, system 100 can generate the output based on a received query. In some examples, the query can be received from participants 106. In some examples, the query can be received from non-participants, for example, a stakeholder who wants to find the output regarding his/her topic of interest. In some examples, the query can be received from a system other than the system 100. The output may be presented by displaying the output on a screen, describing the output audibly via an audio output through a speaker, and/or displaying the output on a hard copy such as a printed piece of paper, among other examples.

FIG. 2 illustrates a block diagram of an example computing device 200 to determine observations about topics in meetings consistent with the disclosure. Computing device 200 can include a processing resource 202 and a memory resource 204. As described herein, the computing device 200 can perform a number of functions related to determining observations about topics in meetings. Processing resource 202 can be a central processing unit (CPU), a semiconductor-based microprocessor, and/or other hardware devices suitable for retrieval and execution of instructions 201, 203, 205, and 207, stored in memory resource 204.

Although the following descriptions refer to a single processor and a single memory resources, the descriptions can also apply to a system with multiple processing resources and memory resources. In such examples, the computing device 200 can be distributed across multiple memory resources with machine-readable storage mediums and the computing device 200 can be distributed across multiple processing resources. Put another way, the instructions executed by the computing device 200 can be stored across multiple machine-readable storage mediums and executed across multiple processors, such as in a distributed or virtual computing environment.

Processing resource 202 can be a central processing unit (CPU), a semiconductor based microprocessor, and/or other hardware devices suitable for retrieval and execution of machine-readable instructions 201, 203, 205, 207, stored in memory resource 204. Processing resource 202 can fetch, decode, and execute instructions 201, 203, 205, and 207. As an alternative or in addition to retrieving and executing instructions 201, 203, 205, and 207, the processing resource 202 can include a plurality of electronic circuits that include electronic components for performing the functionality of instructions 201, 203, 205, and 207.

Memory resource 204 can be any electronic, magnetic, optical, or other physical storage device that stores executable instructions 201, 203, 205, 207, and/or data. Thus, memory resource 204 can be, for example, Random Access Memory (RAM), an Electrically-Erasable Programmable Read-Only Memory (EEPROM), a storage drive, an optical disc, and the like. Memory resource 204 can be disposed within the computing device 200, as shown in FIG. 2. Additionally, and/or alternatively, memory resource 204 can be a portable, external or remote storage medium, for example, that allows the computing device 200 to download the instructions 201, 203, 205, and 207 from a portable/external/remote storage medium.

Computing device 200 can include instructions 201 stored in the memory resource 204 and executable by the processing resource 202 to receive information from a plurality of devices during a meeting. Information received from the plurality of devices can include audio of the meeting, video of the meeting, presentation content and white board content presented during the meeting, among other information.

In some examples, audio information received from the meeting can include audio recording taken by an audio recording device (microphone, speaker, etc.). In some examples, the audio recording device can audibly recognize participants based on sound signals received from the participants and compared with sound signals in a database.

In some examples, video information received from the meeting can include digital images taken by a visual image capturing device. For example, a visual image capturing device (e.g., camera) can take images and/or video of participants.

In some examples, information received from the meeting can include presentation content and white board content presented during the meeting. For example, information received from devices can include digital presentation content and/or whiteboard content from the meetings. In some examples, the visual image capturing device can take images of the presentation content presented in the meetings

Computing device 200 can execute instructions 201 via the processing resource 202 to receive information from devices such as cameras, sensors microphones, phone applications, voice over Internet Protocol (VoIP) applications, voice recognition applications, digital media, etc. For example, computing device 200 can execute instructions 201 via the processing resource 202 to receive information from a camera that can take an image of the participant. In some examples, the image taken by the camera can identify the participant. In some examples, the camera can identify the participant via facial recognition, as described herein.

In some examples, devices can include a sensor that can detect sensory inputs received from the participants. In some examples, sensory input can include enthusiasm, verbal engagement, and physical gesture captured by the devices, as further described herein. The computing device 200 can execute instructions 201 via the processing resource 202 to receive information about the participants from the sensor can detect sensory inputs from the participants.

In some examples, devices can include a microphone that can capture audio of the participants by converting sound waves into electrical signals. The computing device 200 can execute instructions 201 via the processing resource 202 to receive information from the microphone that captures audio of the participants by converting sound waves into electrical signals. In some examples, the computing device 200 can receive information from the microphone, compare the soundwaves with a database of soundwaves to determine the identity of the participants, as discussed herein.

Computing device 200 can include instructions 203, stored in the memory resource 204 and executable by the processing resource 202, to analyze the received information (e.g., such as the audio of a meeting, video of a meeting, presentation content of a meeting, etc.) via machine learning. In some examples, the machine learning can be done by supervised learning. In supervised learning a machine can map a given input to the output. In some examples, the machine learning can be done by unsupervised learning. In unsupervised learning the output for the given input is unknown. The image and/or input can be grouped together and insights on inputs can be used to determine the output. In some examples, the machine learning can be done by semi-supervised learning that is in-between supervised and unsupervised learning. In some examples, the machine learning can be done by reinforced learning. In reinforced learning the machine can learn from past experience to make accurate decisions based on feedback received.

In some examples, instructions 203 to analyze the received information via machine learning can include instructions to cause the processing resource 202 to perform a specific task via machine learning without using explicit instructions, relying on patterns and inferences. For example, received information can include sensory input received from a sensor regarding a participant's enthusiasm level about a specific topic. At 203, the computing device 200 can cause the processing resource 202 to analyze the participant's enthusiasm level and determine whether the participant agrees with a specific topic. In such an example, the computing device 200 can cause the processing resource 202 to make the determination by relating the participant's enthusiasm level, based on past experience, and agreement/disagreement status about the topic. Similarly, machine learning can be used to compare a phrase, physical gesture, content, etc.

In some examples, analyzing the received information can include identifying a meeting participant associated with the received information from the plurality of devices. For example, a camera can take an image of a participant in a meeting and detect the participant via facial recognition. The identity of the participant can be determined by, for instance, comparing facial features of the participant from an image including facial features of the participant taken by the camera, with facial images in a database (not shown in FIG. 2) of facial images. Based on the comparison of the image from camera and the database of facial images, an identity of the participant can be determined. That is, if the facial images of the image from camera match the facial images included in images of the database of facial images, an identity of the participant can be determined. In some examples, the analyzed information can be used to determine an observation about a topic presented during the meeting. Similarly, a participant can be determined by, for instance, comparing audio signals received from the participant with an audio signal database. If the audio signals received from an audio recording device match audio signals included in the audio signal database, an identity of the participant can be determined.

Computing device 200 can include instructions 205, stored in the memory resource 204 and executable by the processing resource 202, to determine an observation about a topic presented during the meeting using the analyzed information. Determining an observation about a topic can streamline workflow and can help track progress of meetings efficiently. In some examples, the topic can be signaled by initial position in the sentence. In some examples, the topic can be signaled by a grammatical marker. For example, a topic can be “finance meeting conducted from June-December 2028”, “patent cases litigated in 2028”, etc.

In some examples, the observation can be categorized based on context. In some examples, computing device 200 can receive information about participants from devices, analyze the information via machine learning, and categorize the observation. For example, instructions 205 can cause the processing resource 202 to determine an observation regarding participants consenting to a topic by comparing previously recorded meetings and/or sensory inputs. In some examples, consent from the participants can be determined by, for instance, comparing keywords used by the participant captured by the microphone with a database (not shown in FIG. 2) of keywords that marks the words as “consent”.

In some examples, the instructions 205 to determine the observation can include instructions to cause the processing resource 202 to determine a sensory input regarding meeting participants during the meeting. In some examples, sensory input can include enthusiasm, verbal engagement, and/or physical gesture captured by the devices. For example, instructions 205 can cause the processing resource 202 to determine verbal engagement of all participants in a meeting during a first time period. Based on certain phrases (e.g., agree, yes) the computing device 200 can determine the observation about the meeting outcome to be positive.

In some examples, instructions 205 can cause the processing resource 202 to make an observation that participants agreed on the first topic based on the participant's enthusiasm captured by devices. The enthusiasm of the participants can be determined by, for instance, comparing energy and interest of the participants with a database of responses received from participants at a different time period about the same and/or a different topic. In some examples, instructions 205 can cause the processing resource 202 to make an observation that participants agreed on the first topic based on the participants physical gesture (e.g., a nod of the head) regarding the first topic.

In some examples, instructions 205 can cause the processing resource 202 to make an observation by identifying a meeting participant who responded to the topic. Response for the topic can include verbal engagement about the topic. For example, computing device 200 can cause the processing resource 202 to make an observation that a first participant and a second participant responded to a topic regarding budget increase based on their input received from the participants during the meeting. Response for the topic can also include sensory input about the topic. For example, instructions 205 can cause the processing resource 202 to make an observation that a third participant responded to the budget increase topic based on physical gesture, for instance, participant taking written notes during the meeting.

In some examples, instructions 205 can cause the processing resource 202 to make an observation by summarizing content presented related to a topic during the meeting. For example, a meeting include a first content presented using digital media, and a second content presented using white board content. In some examples, the contents can be summarized by combining the first and the second contents and providing a brief statement of the topic presented in the contents. For example, first content can include plurality of digital slides portion of which includes budget for 2019. Similarly, the second content can include plurality of topics portion of which includes budget information for 2019. Instructions 205 can cause the processing resource 202 to make an observation by combining the contents related to the budget topic and provide a brief statement of the budget topic.

In some examples, instructions 205 can cause the processing resource 202 to make an observation by direct observations and inferred observations over time related to the meeting relating to the topic for the data model. In some examples, instructions 205 can cause the processing resource 202 to make an observation created in response to an explicit instruction, for instance, instruction to find out the identity of the participants. In some examples, instructions 205 can cause the processing resource 202 to make an observation based on evidence and/or reason. For example, processing resource 202 can determine the first participant consents to a specific topic during a first meeting, second meeting and third meeting. Based on that evidence, processing resource 202 can infer that the first participant may consent to the same topic during a fourth meeting.

In some examples, computing device 200 can cause the processing resource 202 to collate analyzed information to categorize an observation. For example, the processing resource 202 can collect data about a specific topic, categorize the topic based on the observation and organize the topic based on a context, as described herein. Instructions 205, for instance, can cause the processing resource 202 to determine verbal engagement of all participants in a meeting during a second time period. Based on certain phrases (e.g., disagree, no) the computing device 200 can determine the observation about the meeting outcome to be negative.

In some examples, the observations about meetings can be collected and combined to categorize the observation. For example, based on the number of participants who agreed to a topic during the first and the second time period can be collected and combined to categorize the observation as “in agreement” category.

In some examples, the instructions 205 to determine the observation can include instructions to cause the processing resource 202 to track progress about the topic presented during the meeting. For example, instructions 205 can include instructions to cause the processing resource 202 to observe the outcome of the meeting regarding a first topic presented during a first time period, a second period, and a third time period. Based on the outcome for each of the first, second, and third time period, processing resource 202 can track progress about the topic presented during the meetings. In some examples, tracking the progress of the topic can drive future decisions about the topic.

Computing device 200 can include instructions 207 stored in the memory resource 204 and executable by the processing resource 202 to generate an output including the observation. In some examples, the output can be a hard copy, a soft copy, a digitized speech, etc. In some examples, the output can include a direct observation related to the topic. For example, an output can be generated based on a direct observation created in response to an explicit input and/or instruction related to the topic. For example, a participant can submit a query to find out the content presented in a first location. The output in such an instance can be the digital content presented, whiteboard content presented during the meeting from the first location. In some examples, the output can include an inferred observation related to the topic. For example, an output can be generated based on a derived observation created from premised and/or evidence. In some examples, the output can be based on patterns and inferences. In some examples, an output can be based on a natural input. A natural input can include a natural language spoken by participants.

In some examples, processing resource 202 can generate the output based on a received query. In some examples, the query can be received from participants. In some examples, the query can be received from non-participants, for example, a stakeholder who wants to find the output regarding his/her topic of interest. In some examples, the query can be received from a system other than the computing device 200. The output may be presented by displaying the output on a screen, describing the output audibly via an audio output through a speaker, and/or displaying the output

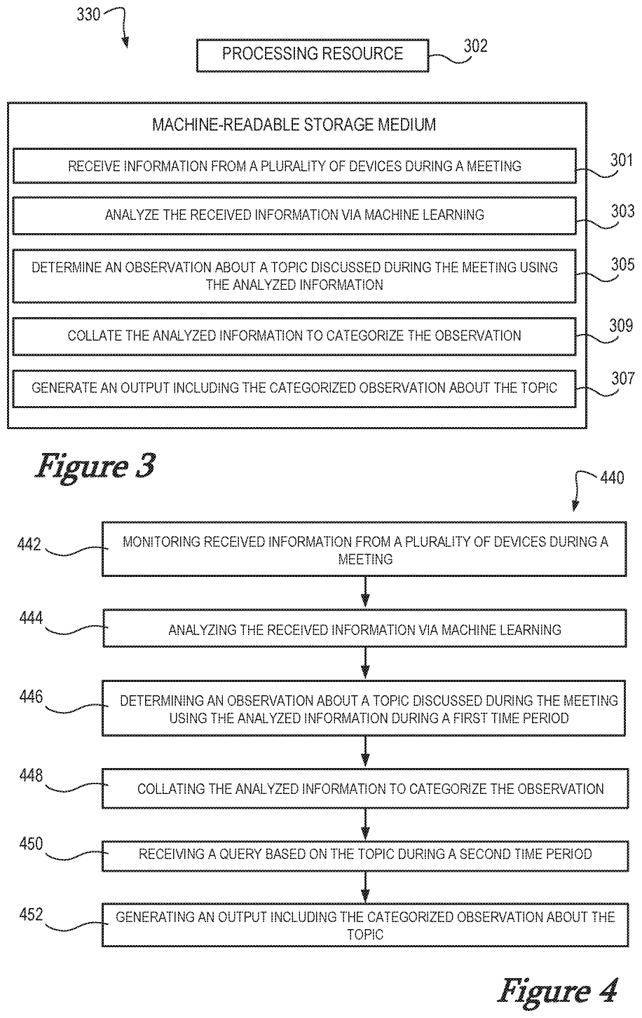

FIG. 3 illustrates a block diagram of an example system 330 consistent with the disclosure. In the example of FIG. 3, system 330 includes a processing resource 302 and a machine-readable storage medium 304. Although the following descriptions refer to an individual processing resource and an individual machine-readable storage medium, the descriptions may also apply to a system with multiple processing resources and multiple machine-readable storage mediums. In such examples, the instructions may be distributed across multiple machine-readable storage mediums and the instructions may be distributed across multiple processing resources. Put another way, the instructions may be stored across multiple machine-readable storage mediums and executed across multiple processing resources, such as in a distributed computing environment.

Processing resource 302 may be a central processing unit (CPU), microprocessor, and/or other hardware device suitable for retrieval and execution of instructions stored in machine-readable storage medium 304. In the particular example shown in FIG. 3, processor 304 may receive, analyze, determine, collate, and generate instructions 301, 303, 305, 309 and 307. As an alternative or in addition to retrieving and executing instructions, processing resource 302 may include an electronic circuit comprising a number of electronic components for performing the operations of the instructions in machine-readable storage medium 304. With respect to the executable instruction representations or boxes described and shown herein, it should be understood that part or all of the executable instructions and/or electronic circuits included within one box may be included in a different box shown in the figures or in a different box not shown.

Machine-readable storage medium 304 may be any electronic, magnetic, optical, or other physical storage device that stores executable instructions. Thus, machine-readable storage medium 304 may be, for example, Random Access Memory (RAM), an Electrically-Erasable Programmable Read-Only Memory (EEPROM), a storage drive, an optical disc, and the like. The executable instructions may be “installed” on the system 330 illustrated in FIG. 3. Machine-readable storage medium 304 may be a portable, external or remote storage medium, for example, that allows the system 330 to download the instructions from the portable/external/remote storage medium. In this situation, the executable instructions may be part of an “installation package”. As described herein, machine-readable storage medium 304 may be encoded with executable instructions for determining observations about topics in meetings.

Instructions 301, when executed by a processing resource such as processing resource 302, can cause system 330 to receive information from a plurality of devices during a meeting. Information received from the plurality of devices can include audio of the meeting, video of the meeting, presentation content and white board content presented during the meeting.

In some examples, audio information received from the meeting can include audio recording taken by an audio recording device (microphone, speaker, etc.). In some examples, the audio recording device can audibly recognize participants based on sound signals received from the participants and compared with sound signals in a database.

In some examples, video information received from the meeting can include digital images taken by a visual image capturing device. For example, a visual image capturing device (e.g., camera) can take images of participants.

In some examples, information received from the meeting can include presentation content and white board content presented during the meeting. For example, information received from devices can include digital presentation content and/or whiteboard content from the meetings. In some examples, the visual image capturing device can take images of the presentation content presented in the meetings

System 330 can execute instructions 301 via the processing resource 302 to receive information from, cameras, sensors microphones, phone applications, voice over Internet Protocol (VoIP) applications, voice recognition applications, digital media, etc. For example, system 330 can execute instructions 301 via the processing resource 302 to receive information from a camera that take an image of the participant. In some examples the image taken by the camera can identify participant. In some examples, the camera can identify the participant via facial recognition, as described herein.

Instructions 303, when executed by a processing resource such as processing resource 302, can cause system 330 to analyze the received information (e.g., such as the audio of a meeting, video of a meeting, presentation content of a meeting, etc.) via machine learning. In some examples, analyzing the received information can include identifying a meeting participant associated with the received information from the plurality of devices. For example, a camera can take an image of a participant in a meeting and detect the participant via facial recognition. The identity of the participant can be determined by, for instance, comparing facial features of the participant from an image including facial features of the participant taken by the camera, with facial images in a database of facial images. Based on the comparison of the image from camera and the database of facial images, an identity of the participant can be determined. That is, if the facial images of the image from camera match the facial images included in images of the database of facial images, an identity of the participant can be determined. In some examples, the analyzed information can be used to determine an observation about a topic presented during the meeting. Similarly, a participant can be determined by, for instance, comparing audio signals received from the participant with an audio signal database. If the audio signals received from an audio recording device match audio signals included in the audio signal database, an identity of the participant can be determined.

Instructions 305, when executed by a processing resource such as processing resource 302, can cause system 330 to determine an observation about a topic presented during the meeting using the analyzed information. In some examples, the topic can be signaled by initial position in the sentence. In some examples, the topic can be signaled by a grammatical marker. For example, a topic can be “finance meetings conducted from June-December 2028”, “patent cases litigated in 2028”, etc.

In some examples, the instructions 305 executed by a processing resource such as processing resource 302, can cause system 330 to determine an observation about a topic by receiving sensory input from a sensor. Sensory input can include enthusiasm, verbal engagement, physical gesture captured by the devices. For example, processing resource 302 can determine verbal engagement of all participants in a meeting during a first time period. Based on certain phrases (e.g., agree, yes) the system 330 can determine the observation about the meeting outcome to be positive.

Instructions 305, when executed by a processing resource such as processing resource 302, can cause system 330 to determine observation that participants agreed on the first topic based on the participant's enthusiasm captured by devices. The enthusiasm of the participants can be determined by, for instance, comparing energy and interest of the participants with a database of responses received from participants at a different time period about the same and/or a different topic. In some examples, system 330 can make an observation that participants agreed on the first topic based on the participants physical gesture (e.g., a nod of the head) regarding the first topic.

Instructions 305, when executed by a processing resource such as processing resource 302, can cause system 330 to determine an observation by identifying meeting participants who responded to the topic. Responses for the topic can include verbal engagement about the topic. For example, system 305 can cause the processing resource 302 to make an observation that a first participant and a second participant responded to a topic regarding budget increase based on their input received from the participants during the meeting. Responses for the topic can also include sensory input about the topic. For example, instructions 305 can cause the processing resource 302 to make an observation that a third participant responded to the budget increase topic based on physical gesture, for instance participant taking written notes during the meeting.

Instructions 305, when executed by a processing resource such as processing resource 302, can cause system 330 to make an observation by summarizing content presented during the meeting. For example, a meeting include a first content presented using digital media, and a second content presented using white board content. In some examples, the contents can be summarized by combining the first and the second contents and providing a brief statement of the topic presented in the contents. For example, first content can include plurality of digital slides portion of which includes budget for 2019. Similarly, the second content can include plurality of topics portion of which includes budget information for 2019. Instructions 305 can cause the processing resource 302 to make an observation by combining the contents related to the budget topic and summarize the content.

In some examples, instructions 305 can cause the processing resource 302 to make an observation by tracking progress about the topic presented during the meeting. For example, an observation can be made about the first meeting during a first time period, and a second meeting during a second time period. Based on the information received from the two meetings, instructions 305 can cause the processing resource 302 to track progress. For example, system 330 can track that the topic presented during the first and the second meeting has reached a milestone.

In some examples, instructions 305 can cause the processing resource 302 to make an observation by direct observations and inferred observations over time related to the meeting relating to the topic for the data model. In some examples, instructions 305 can cause the processing resource 302 to make an observation created in response to an explicit instruction, for instance, instruction to find out the identity of the participants. In some examples, instructions 305 can cause the processing resource 302 to make an observation based on evidence and/or reason. For example, processing resource 302 can determine the first participant consents to a specific topic during a first meeting, second meeting and third meeting. Based on that evidence, processing resource 302 can make an observation inferring that the first participant may consent to the same topic during a fourth meeting

Instructions 309, when executed by a processing resource such as processing resource 302, can cause system 330 to collate the analyzed information to categorize the observation. For example, the processing resource 302 can collect data about a specific topic, categorize the topic based on the observation and organize the topic based on a context, as described herein. instructions 309 can cause the processing resource 302 to determine verbal engagement of all participants in a meeting during a second time period. Based on certain phrases (e.g., disagree, no) the system can determine the observation about the meeting outcome to be negative. In some examples, the observations about meetings can be collected and combined to categorize the observation. For example, based on the number of participants who agreed to a topic during the first and the second time period can be collected and combined to categorize the observation as “in agreement” category.

Instructions 307, when executed by a processing resource such as processing resource 302, can cause system 330. generate an output including the categorized observation about the topic. In some examples, the output can be a hard copy, a soft copy, a digitized speech, etc. In some examples, the output can include a direct observation related to the topic. For example, an output can be generated based on a direct observation created in response to an explicit input and/or instruction related to the topic. For example, a participant can submit a query to find out the content presented in a first location. The output in such an instance can be the digital content presented, whiteboard content presented during the meeting from the first location. In some examples, the output can include an inferred observation related to the topic. For example, an output can be generated based on a derived observation created from premised and/or evidence. In some examples, the output can be based on patterns and inferences. In some examples, an output can be based on a natural input. A natural input can include a natural language spoken by participants.

In some examples, processing resource 302 can generate the output based on a received query. In some examples, the query can be received from participants. In some examples, the query can be received from non-participants, for example, a stakeholder who wants to find the output regarding his/her topic of interest. In some examples, the query can be received from a system other than the system 300. The output may be presented by displaying the output on a screen, describing the output audibly via an audio output through a speaker, and/or displaying the output

FIG. 4 illustrates an example of a method 440 for determining observations about topics in meetings consistent with the disclosure. Method 440 can be performed by a computing device (e.g., 200 previously described in connection with FIG. 1).

At 442, the method 440 can include, monitoring, by a computing device, information received from a plurality of devices during a meeting. Information received from the plurality of devices can include audio of the meeting. video of the meeting, presentation content and white board content presented during the meeting.

At 444, the method 440 can include, analyzing, by the computing device, the monitored information (e.g., such as the audio of a meeting, video of a meeting, presentation content of a meeting, etc.) via machine learning. In some examples, analyzing the received information can include identifying a meeting participant associated with the received information from the plurality of devices. For example, a camera can take an image of a participant in a meeting and detect the participant via facial recognition. The identity of the participant can be determined by, for instance, comparing facial features of the participant from an image including facial features of the participant taken by the camera, with facial images in a database of facial images. Based on the comparison of the image from camera and the database of facial images, an identity of the participant can be determined. That is, if the facial images of the image from camera match the facial images included in images of the database of facial images, an identity of the participant can be determined. In some examples, the analyzed information can be used to determine an observation about a topic presented during the meeting. Similarly, a participant can be determined by, for instance, comparing audio signals received from the participant with an audio signal database. If the audio signals received from an audio recording device match audio signals included in the audio signal database, an identity of the participant can be determined.

At 446, the method 440 can include determining, by the computing device, an observation about a topic presented in the meeting during a first time period. In some examples, the observation about the topic can include determining sensory input from a participant received from a sensor. Sensory inputs can include enthusiasm, verbal engagement, physical gesture captured by the devices.

In some examples, the observation can include identifying meeting participants who responded to the topic. Responses for the topic can include verbal engagement about the topic. Responses for the topic can include sensory input about the topic. Responses for the topic can include physical gesture of the participants during the meeting.

In some examples, the observation can include summarizing content presented during the meeting related to a topic. For example, content can include content presented using digital media, and content presented using white board related to the topic. In some examples, the computing device can summarize the content by combining the contents and detecting the general idea of the content related to the topic.

In some examples, the observation can include tracking progress about the topic presented during the meeting. For example, the computing device can make an observation about the first meeting during a first time period, and a second meeting during a second time period. Based on the information received from the two meetings, the computing device can track progress.

In some examples, the observation can include making an observation that includes direct observations and inferred observations over time related to the meeting relating to the topic for the data model.

At 448, the method 440 can include collating, by the computing device, the analyzed information to determine a category associated with the observation. In some examples the method 440 can, at 448, collate the analyzed information to categorize an observation. For example, method 440 can collect data about a specific topic, categorize the topic based on the observation, and organize the topic based on a context, as described herein.

At 450, method 440 can include receiving, by the computing device, a query based on the topic during a second time period. For example, a participant can submit a query to find out the content presented during a first time period involving the same topic. In some examples, the percipient can submit a query to find out participants other than the participant attended the meeting from other meeting locations.

At 452, method 440 can include generating, by the computing device, an output based on the query during the second time period. In some examples, the output can be a hard copy, a soft copy, a digitized speech, etc. In some examples, the output can include a direct observation related to the topic. For example, an output can be generated based on a direct observation created in response to an explicit input and/or instruction related to the topic

The figures herein follow a numbering convention in which the first digit corresponds to the drawing figure number and the remaining digits identify an element or component in the drawing. For example, reference numeral 202 can refer to element 202 in FIG. 2 and an analogous element can be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements can be present. In contrast, when an object is “directly coupled to” or “directly coupled with” another element it is understood that are no intervening elements (adhesives, screws, other elements), etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device comprising:
a processing resource; and
a memory resource storing machine readable instructions a e the processing resource to:
receive information from a plurality of devices during a meeting;
analyze the received information via machine learning;
determine an observation about a topic presented during the meeting using the analyzed information; and
generate an output including the observation.

2. The computing device of claim 1, wherein the instructions to determine the observation include instructions to cause the processing resource to determine a sensory input regarding meeting participants during the meeting.

3. The computing device of claim 1, wherein the instructions to determine an observation include instructions to cause the processing resource to identify a meeting participant who responded to the topic.

4. The computing device of claim 1, wherein the instructions to determine an observation include instructions to cause the processing resource to summarize content presented during the meeting related to the topic.

5. The computing device of claim 1, wherein the instructions to determine an observation include instructions to cause the processing resource to track progress about the topic presented during the meeting.

6. The computing device of claim 1, wherein the information received from the plurality of devices includes at least one of:
audio of the meeting;
video of the meeting;
presentation content presented during the meeting; and
white board content presented during the meeting.

7. The computing device of claim 1, wherein the output includes at least one of a direct observation related to the topic and an inferred observation related to the topic.

8. A non-transitory computer readable medium storing instructions executable by a processing resource to cause the processing resource to:
receive information from a plurality of devices during a meeting;
analyze the received information via machine learning;
determine an observation about a topic presented during the meeting using the analyzed information;
collate the analyzed information to categorize the observation; and
generate an output including the categorized observation about the topic.

9. The medium of claim 8, wherein the instructions to collate the analyzed information include instructions to build a data model to generate context-specific outputs based on the topic.

10. The medium of claim 9, comprising instructions to collect direct observations and inferred observations over time related to the meeting relating to the topic for the data model.

11. The medium of claim 10, comprising instructions to collect the direct observations and the inferred observations related to the meeting in real time.

12. The medium of claim 8, comprising instructions to gene ate he output based on a received query.

13. A method, comprising:
monitoring, by a computing device, information received from a plurality of devices during a meeting;
analyzing, by the computing device, the monitored information via machine learning;
determining, based on the analyzed information, by the computing device, an observation about a topic presented in the meeting during a first time period;
collating, by the computing device, the analyzed information to determine a category associated with the observation;
receiving, by the computing device, a query based on the topic during a second time period; and
generating, by the computing device, an output based on the query during the second time period.

14. The method of claim 13, wherein the method includes identifying a meeting participant associated with the received information from the plurality of devices.

15. The method of claim 13, wherein the method includes generating at least one of a direct output and an inferred output based on a natural input.
